(19) United States
(12) Patent Application Publication
(10) Pub. No.: US 2018/0012326 A1
(43) Pub. Date: Jan. 11, 2018

(54) System and Method for Distributing Product Samples to Promote Sales in an Ornamental and Pressure-Free Environment

(71) Applicant: MARIAN CUELLO, Miami, FL (US)

(72) Inventor: MARIAN CUELLO, Miami, FL (US)

(21) Appl. No.: 15/204,137

(22) Filed: Jul. 7, 2016

(51) Int. Cl. G06Q 90/00; G09B 25/00

(52) U.S. Cl. CPC G06Q 90/00; G09B 25/00

(57) ABSTRACT

A system and method for distributing product samples to promote sales in an ornamental and pressure-free environment. The system allows a consumer to sample a product and become educated about the product in an ornamental, strategically illuminated chamber, and with no sales pressure. The chamber includes a product section that displays product samples that correlate to products. The product samples are displayed from multiple modules, aesthetically arranged throughout the product section. A radial illumination assembly, which is shaped similar to a snowflake, illuminates the modules to strategically enhance the display of product samples and create a pleasant product sampling experience. The chamber includes a registration section to collect information from the consumer. The chamber includes an educational section to educate the consumer about the product. The chamber includes a product collection section that provides the option of performing a purchase transaction for the product, or receiving a free product bundle.

### BACKGROUND

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The present invention is directed to a system and method for distributing product samples to promote sales in an ornamental and pressure-free environment.

The inventor is involved in marketing products and services to consumers through various known marketing schemes. The inventor was aware of one marketing apparatus—the free product sample. The inventor had experienced that product samples offered an effective means to introduce consumers to a product. The inventor was also aware that manufacturers and distributors benefit from consumers' sampling of their new and improved products. Free product sampling enables manufacturers to generate repeat usage, have access to their target consumers, and receive consumer feedback.

The inventor decided to provide a system and method that created free product sampling to support the launch of a new product. The inventor recognized a problem from observing at various trade shows and shopping centers that many consumers were deterred from attempting to obtain product samples because of the high pressure sales tactics that were usually involved.

The inventor created a show room that had multiple displays for presenting product samples. The show room did not have any sales people present. The show room did not attempt to sell the products associated with the product samples. The consumer was free to wander through the show room uninterrupted. The inventor quickly saw that forming the show room into a circular path with one-way traffic allowed the consumers to be funneled past all of the product samples.

The inventor was also aware that an important consideration in successfully selling a product is to make the product for sale look appealing to and catch the attention of potential consumers. One way to accomplish this is to use lighting, colors, shapes, and unusual package designs. Through additional research, the inventor learned that a radial illumination enhanced the entire circular shape of the show room and allowed all of the products to be well lighted. The inventor recognized that a snowflake shape provided multiple arms that could carry lighting directly over or proximal to the separate modules displaying the product samples.

The inventor also knew about registering the consumer to obtain marketing information. In prior art methods, a sample product was often distributed to consumers with information for the consumer to unilaterally contact the manufacturer, for either additional samples or coupons to purchase the sampled products at a discount. The manufacturer normally requires basic information from the consumer before providing either the additional sample or coupons. Such consumer data is then stored in a database for future marketing purposes.

The inventor decided to streamline the information collection process by integrating a registration section into the show room. The registration section would allow the consumer to input personal information, preferably through an automated input device that did not pressure the consumer into transacting a purchase. The inventor knew that this information could be used for future marketing of the consumer. The inventor also added an education section to educate the consumer about the product.

However, the inventor still wondered how to generate additional revenue, even with free samples. Thus to generate revenue, the inventor integrated a product collection section into the show room, near the exit. The product collection section was designed to offer the consumer an option to receive the product or product sample for free, or purchase the product. The consumer could now receive a free product bundle consisting of the product or product sample, or both. The consumer also had the the option of transacting a purchase of any the products that were displayed at the modules, which met the inventor's goal of generating additional revenue.

For the foregoing reasons, there is a system and method for distributing product samples to promote sales in an ornamental and pressure-free environment. The system and method provides an ornamental environment for a consumer to access product samples and receive an education about a product in an aesthetic, strategically lighted chamber, with no sales pressure, and an option to receive a free product bundle or transact a purchase based on the experience with the product sample and the education received about the product.

Product marketing and free sample methods have been utilized in the past yet none with the characteristics of the present invention. See U.S. Pat. Nos. 7,086,751; 20080040213; and 20100257017.

For the foregoing reasons, there is a delivery method and device that allows a delivery vehicle to pass through a resident lane in a private community and avoid a guest lane through the use of an identifying signal emitted from a transponder or through optical character recognition technology of a license plate.

### SUMMARY

The present invention describes a system and method for distributing product samples to promote sales in an ornamental and pressure-free environment. The system and method provides an ornamental environment for a consumer to access product samples and receive an education about a product. The system and method enhances the education and sampling experience through a strategically illuminated environment that illuminates the product and samples thereof to create a pleasant, psychological experience for the consumer. The system and method also enhances the education and sampling experience for the consumer by eliminating high pressure sales techniques and sales people. Thus, the consumer is allowed to voluntarily request samples of the products in an ornamental, strategically illuminated environment with minimal pressure to commit to a purchase; thereby causing the consumer to be more inclined to purchase the product in the future.

The system provides an ornamental, strategically illuminated environment, defined by a spacious chamber that allows the consumer to wander freely from product-to-product, sampling products, and with no sales pressure from a salesperson or marketing apparatus. The chamber may be arranged similarly to a convention center, or a show room, or a sampling room that are often used to promote products and services.

In some embodiments, the chamber may include an entry section where the consumer initially enters the chamber. The consumer does not pay a fee to enter the chamber through the entry section. This cost-free aspect of the system and method is efficacious for creating a pressure free environment that enables the consumer to sample and learn about the products for potentially no cost at all.

In one embodiment, a registration section is disposed adjacent to the entry section. The consumer registers at the registration section by providing information at an information input portion. The information input portion, may include, without limitation, a digital display, a data entry person, a card reading device, and a paper form.

The consumer registers information, such as personal information, demographics, desired products, history of purchasing products, preferred payment methods, and the like into the information input portion. Through initial collection of information from the potential consumer, the system can more efficiently match the consumer with the products that are displayed for sampling in the chamber. The information provided by the consumer during the registration process may also be used to market to the consumer at a future time.

The chamber includes a product section. The product section is generally the largest section of the chamber, where customized versions of the products are available for sampling. The product section comprises a plurality of modules for displaying and distributing the product samples. The modules also provide media for educating the consumer about the products. The modules may include a table or stand that clearly displays the product samples, or literature explaining the product, and information pertinent to the product. These may be displayed on a product display, such as a decorative stand.

At an individual module, the consumer can easily access the product samples to sample, or review product media study the product. This facilitated access to the product samples, without requiring the consumer to make a purchase, create a pressure free environment for the consumer. The modules are unmanned. Also, there are no robotic or video personalities to promote the product at the module. Thus, the consumer may sample the product with no pressure to make a purchase.

A radial illumination assembly is disposed in the chamber. The radial illumination assembly emits light onto the modules in such a manner, so as to enhance the consumer's experience while sampling and learning about the products. In one embodiment, the radial illumination assembly hangs from a ceiling of the chamber. Though in other embodiments, the radial illumination assembly may hang from the sidewalls or from beneath a transparent floor surface. The radial illumination assembly is configured to illuminate each module with a unique light intensity and color that corresponds to the product sample on display. The radial illumination enhances aesthetics and visibility of the product samples. This radially emitted illumination also helps to create a pleasant, stress-free environment for the consumer, so as to enable the consumer to more comfortably sample and learn about the product.

The radial illumination assembly comprises a center region and a plurality of arms that extend in a radial disposition from the center region. The arms may be symmetrical, creating a multi-fold radial symmetry shape. In one embodiment, the multi-fold radial symmetry shape forms a snowflake shape. The arms are disposed to position proximally to the modules. The arms are configured to carry a plurality of lights, with each light correlating to a module. In one embodiment, the color and intensity of the lights vary. In another embodiment, the color and intensity of the lights are identical.

The chamber also includes an education section to help explain the products to the consumer. The education section may include a kiosk, a sales person, or a help desk for displaying and distributing educational media that is pertinent to the product sample. The educational media may include, without limitation, written literature, videos, technical literature, and live-person product demonstrations designed to educate the consumer about the product. The consumer is free to visit the education section of the chamber, or bypass the education chamber. This freedom of movement reduces pressure on the consumer to make a purchase.

The chamber also includes a product collection section that offers the consumer an option to receive the product or product sample for free, or purchase the product. The consumer may receive a product bundle consisting of the product or product sample, or both. The consumer also has the option of transacting a purchase of any the products that were displayed at the modules. The product collection section may be the final section the consumer has access to prior to departing the chamber.

As with the education section, the consumer is free to visit the product collection section, or bypass the product collection section. This freedom of movement reduces pressure on the consumer to make a purchase. The product collection section may include a point-of-collection portion to transact purchases of the product. The point-of-collection portion, may include, without limitation, a sales clerk, a vending machine, and an automated sales kiosk.

In one aspect, a method for distributing product samples to promote sales in an ornamental and pressure-free environment, comprises an initial Step of providing a chamber, the chamber comprising an entry section, a registration section, a product section having a plurality of modules, an education section, and a purchase section. A Step may further include displaying, at the plurality of modules, a product sample correlating to a product.

In some embodiments of the method, a Step comprises providing a radial illumination assembly configured to illuminate the product sample, the radial illumination assembly comprising center region and a plurality of arms disposed to extend radially from the center region, the plurality of arms carrying a plurality of lights configured to emit light towards the plurality of modules.

Another Step involves registering, at the registration section, a consumer, the registration comprising collecting information from the consumer. A Step may include allowing, at the plurality of modules, the consumer to sample the product sample. A Step comprises educating, at the education section, the consumer about the product correlating to the product sample. A final Step comprises allowing, at the product collection section, the consumer an option to perform a transaction for the product, or receive a free product bundle, the product bundle comprising the product or the product sample or both.

One objective of the present invention is to provide an ornamental, pressure free environment for a consumer to sample products.

Another objective of the present invention is to eliminate salespeople from a showroom or convention center.

Another objective of the present invention is to provide radial illumination on the products displayed at multiple modules, whereby the radial illumination enhances aesthetics and visibility of the product samples.

Another objective of the present invention is to vary the lighting to accommodate different product samples.

Yet another objective of the present invention is to collect information about the consumer for matching with the appropriate product and future marketing.

Yet another objective is to educate the consumer about the product correlating to the product sample.

Yet another objective is to provide the consumer with an option of purchasing the product or receiving a free product bundle comprising of the product or the product sample or both.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### DRAWINGS

These and other features, aspects, and advantages of the present invention will become better understood with regard to the following description, appended claims, and drawings where:

FIG. 1 is a top view of a diagram illustrating an exemplary system for distributing product samples to promote sales in an ornamental;

FIG. 2 is a top view of an exemplary chamber and integrated sections of the chamber;

FIG. 3 is a perspective view of the chamber and an exemplary radial illumination assembly for lighting the modules carrying product samples; and

FIG. 4 is a flowchart illustrating an exemplary method for distributing product samples to promote sales in an ornamental.

### DESCRIPTION

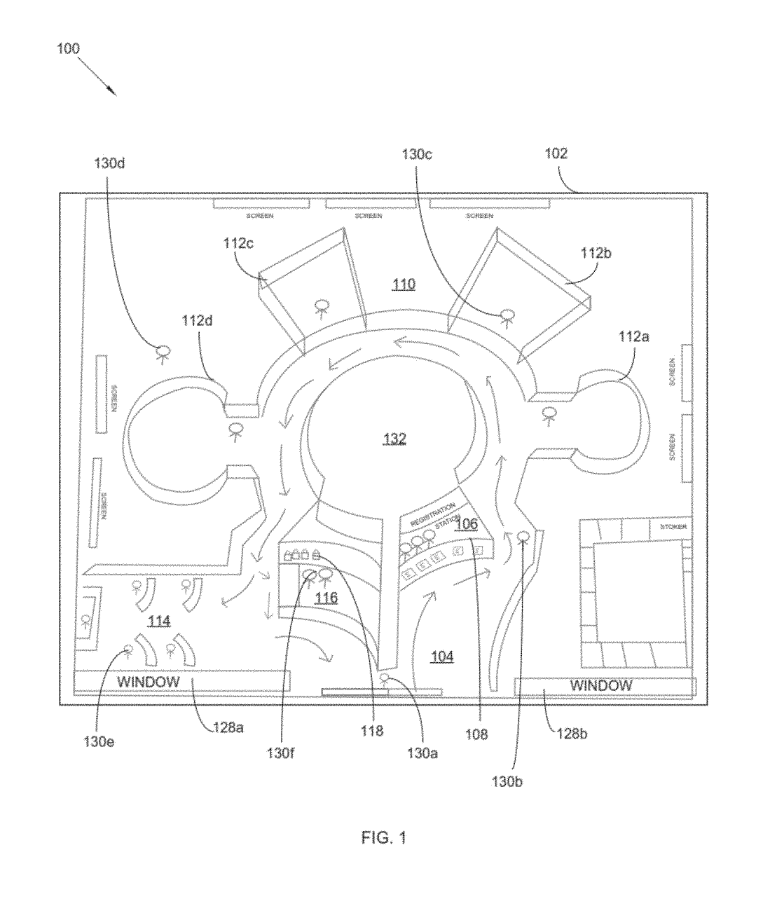

The present invention is directed to a system 100 and method 200 for distributing product samples to promote sales in an ornamental, strategically illuminated, and pressure-free environment, as referenced in FIGS. 1-4. The system 100 and method 200 provides an ornamental environment for at least one consumer 130a-f to access product samples and receive an education about a product in an aesthetic, strategically lighted chamber 102, with no sales pressure, and an option to receive a free product bundle or transact a purchase based on the experience with the product sample and the education received about the product.

As referenced in FIG. 1, the system 100 allows at least one consumer 130a-f to sample a product for potential purchase of the product, or simply for learning more about the product. The system 100 also allows the consumer 130a-f to receive an education about the product through various educational media and live person demonstrations. These promotional functions are performed with no sales pressure, since a salesperson or marketing apparatus is not employed within the system 100. Thus, the consumer 130a-f is allowed to voluntarily request samples of the products while immersed in an ornamental, strategically illuminated environment with minimal pressure to commit to a purchase; thereby potentially causing the consumer 130a-f to be more inclined to purchase or recommend the product in the future.

In some embodiments, the consumer 130a-f may include a potential purchaser of the product, a prior purchaser of the product, a product reviewer, an inventory manager, and a government inspector. The product may include, without limitation, a commercially available item, a service, a free item or service offered by a government agency, and a packet of information.

In one embodiment, the system 100 provides an ornamental, strategically lighted environment that is defined by a spacious chamber 102. The consumer 130a-f may wander freely through the chamber 102 moving from product-to-product, sampling products, inquiring about products, and receiving no sales pressure from a salesperson or marketing apparatus.

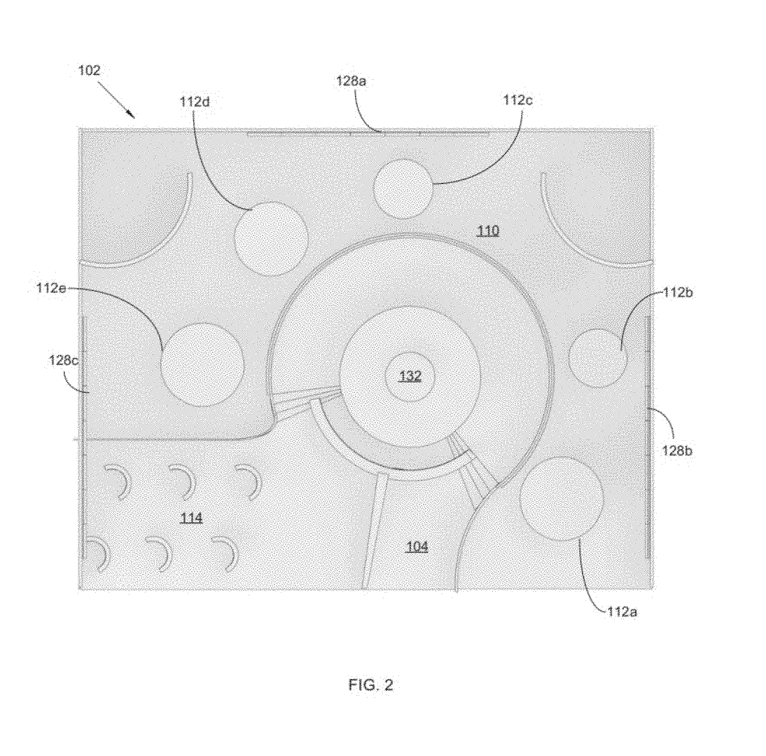

Turning now to FIG. 2, the chamber 102 follows a generally circular pattern, whereby the consumer 130a-f walks around a central hub 132 to view and access multiple product samples. Further, the chamber 102 may include a series of windows 128a, 128b, 128c that enable visibility into the chamber 102 to help attract attention to the modules 112a-e and draw potential consumer 130a-fs into the chamber 102. In some embodiments, the chamber 102 may be arranged similarly to a convention center, a show room, or a sampling room, which are known in the art to promote products and services.

The chamber 102 comprises an entry section 104 where the consumer 130a-f initially enters the chamber 102. The consumer 130a-f does not pay a fee to enter the chamber 102 through the entry section 104. This cost-free aspect of the system 100 is efficacious for creating a pressure free environment that enables the consumer 130a-f to sample and learn about the products for potentially no cost at all.

In one embodiment, a registration section 106 is disposed adjacent to the entry section 104. The consumer 130a-f registers at the registration section 106 by providing information at an information input portion 108. The information input portion 108, may include, without limitation, a digital display, a data entry person, a card reading device, and a paper form.

The consumer 130a-f registers information, such as personal information, demographics, desired products, history of purchasing products, preferred payment methods into the information input portion 108. Through initial collection of information from the consumer 130a-f, the system 100 can more efficiently match the consumer 130a-f with the products that are displayed for sampling in the chamber 102. The information provided by the consumer 130a-f during the registration process may also be used to market to the consumer 130a-f at a future time. In one exemplary use of the information input portion 108, a consumer 130a-f inputs name, address, email, and preferred products manually through a touch screen display.

The chamber 102 further includes a product section 110. The product section 110 is generally the largest section of the chamber 102, where customized versions of the products are available for sampling. The product section 110 may be configured as a large, circular room with a concentric central hub 132. A circular pathway may provide a one-way traffic pattern to reduce confusion and funnel the consumer 130a-f past all of the product samples. This facilitated access to the product samples, without requiring the consumer 130a-f to make a purchase, creates a pressure free environment for the consumer 130a-f.

The product section 110 comprises a plurality of modules 112a-e for displaying and distributing the product samples. The modules 112a-e are disposed in a spaced-apart relationship. The modules 112a-e also provide media for educating the consumer 130a-f about the products. The modules 112a-e may include a table or stand that clearly displays the product samples, or literature explaining the product, and information pertinent to the product. The product sample and the literature may be displayed on a product display, such as a decorative stand. Business cards may also be displayed on the product display. The business cards may include a producer or a distributor of the product.

As illustrated in FIG. 1, at an individual module 112a the consumer 130a can easily access the product samples to sample, or review literature and other media that are pertinent to the product. For example, the consumer 130a-f can try on a fragrance, or check the durability of a sandpaper product while standing next to the module 112a-e. The modules 112a-e are unmanned. Also, there are no robotic or video personalities to promote the product at the module. Thus, the consumer 130a-f may sample the product with no pressure to make a purchase.

A radial illumination assembly 120 is disposed in the chamber 102 to illuminate the product samples. The radial illumination assembly 120 emits light in a generally radial pattern and in a variety of illumination intensities and colors. In one embodiment, the color and intensity of the lights 126a-c vary. In another embodiment, the color and intensity of the lights 126a-c are identical. In any case, the radial illumination assembly 120 illuminates the modules 112a-e in such a manner, so as to enhance the consumer's 130a-f experience while sampling and learning about the product.

In one embodiment, the radial illumination assembly 120 hangs from a ceiling of the chamber 102. Though in other embodiments, the radial illumination assembly 120 may hang from the sidewalls or from beneath a transparent floor surface in the chamber 102. The radial illumination assembly 120 is configured to illuminate each module 112a-e with a unique light intensity and color that corresponds to the product sample on display.

For example, a soothing white light emits towards a module displaying samples of a bath product, while harsh red light emits towards a module displaying samples of racing tires. In this manner, the radial illumination enhances aesthetics and visibility of the product samples. The radially emitted illumination also helps to create a relaxed environment for the consumer 130a-f, so as to enable the consumer 130a-f to move through the chamber for sampling and learning about the product.

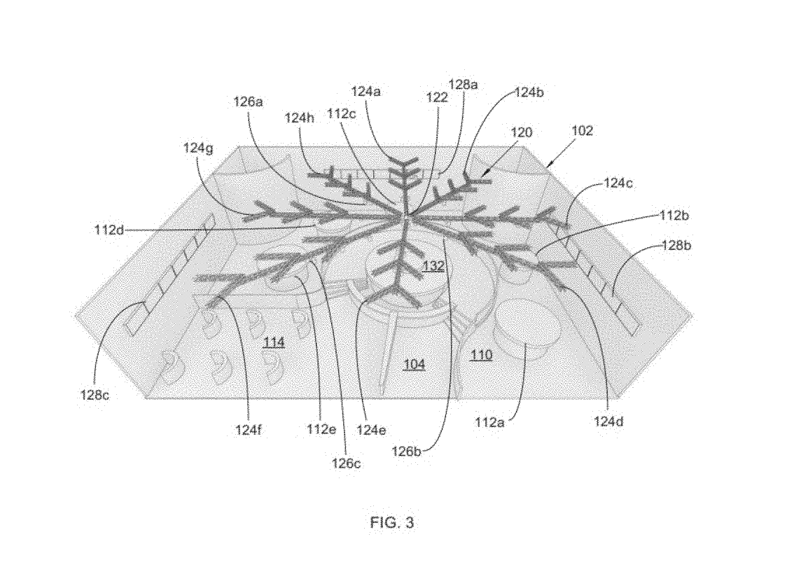

As shown in FIG. 3, the radial illumination assembly 120 comprises a center region 122 and a plurality of arms 124a-h that extend in a radial disposition from the center region 122. The arms 124a-h may be symmetrical, creating a multi-fold radial symmetry shape. The arms 124a-h may have multiple branches that extend outwardly therefrom in a symmetrical pattern. In one embodiment, the multi-fold radial symmetry shape of the radial illumination assembly 120 forms a snowflake shape. The snowflake shape provides both a decorative appearance for aesthetic illumination of the modules 112a-e, and a radial configuration for the functionality of strategic lighting of the modules 112a-e.

The center region 122 of the radial illumination assembly 120 may include a light source, a power source, and a bracket for mounting the radial illumination assembly 120 to a ceiling above the chamber 102. The arms 124a-h are disposed to position proximally to the modules 112a-e. The arms 124a-h are configured to carry a plurality of lights 126a-c, with each light correlating to a module. In one embodiment, the radial illumination assembly 120 may be rotated, so as to reposition a light 126a over a selected module 112a.

The chamber 102 also includes an education section 114. The education section 114 is an optional section of the chamber 102, where the consumer 130a-f may receive help in better understanding the products and information pertinent to the products, such as specs, prices, and delivery options. The education section 114 may include a kiosk, a sales person, or a help desk that are set up to display and distribute educational media that is pertinent to the product sample. The educational media may include, without limitation, written literature, videos, technical literature, and live-person product demonstrations designed to educate the consumer 130a-f about the product. The consumer 130a-f is free to visit the education section 114 of the chamber 102, or bypass the education chamber 102. This freedom of movement reduces pressure on the consumer 130a-f to make a purchase.

The chamber 102 also includes a product collection section 116. The product collection section 116 may be disposed near an exit of the chamber 102. The product collection section 116 offers the consumer 130a-f an option to receive the product or product sample for free, or perform a purchase transaction to purchase the product. The consumer 130a-f may receive a free product bundle consisting of the product or product sample, or both. In one example of the consumer 130a-f receiving a free product bundle, a retailer may include discounts within a grab bag full of the product samples. One grab bag may promote, “buy this product in Macy's this week and receive a 20% discount”. This type of low pressure marketing could drive more sales for retailers.

The consumer 130a-f also has the option of transacting a purchase for the products that are displayed at the modules 112a-e. The product collection section 116 may include a point-of-collection portion 118 to transact purchases of the product in various means known in the art, such as cash, credit card, Paypalm, and checks. The point-of-collection portion 118 is also used to provide the consumer 130a-f with the free product bundle.

The point-of-collection portion 118 may include, without limitation, a sales clerk, a vending machine, and an automated sales kiosk. As with the education section 114, the consumer 130a-f is free to visit the product collection section 116, or bypass the product collection section 116. This freedom of movement reduces pressure on the consumer 130a-f to make a purchase. Thus as shown in FIG. 1, the product collection section 116 is the final section the consumer 130a-f has access to prior to departing the chamber 102.

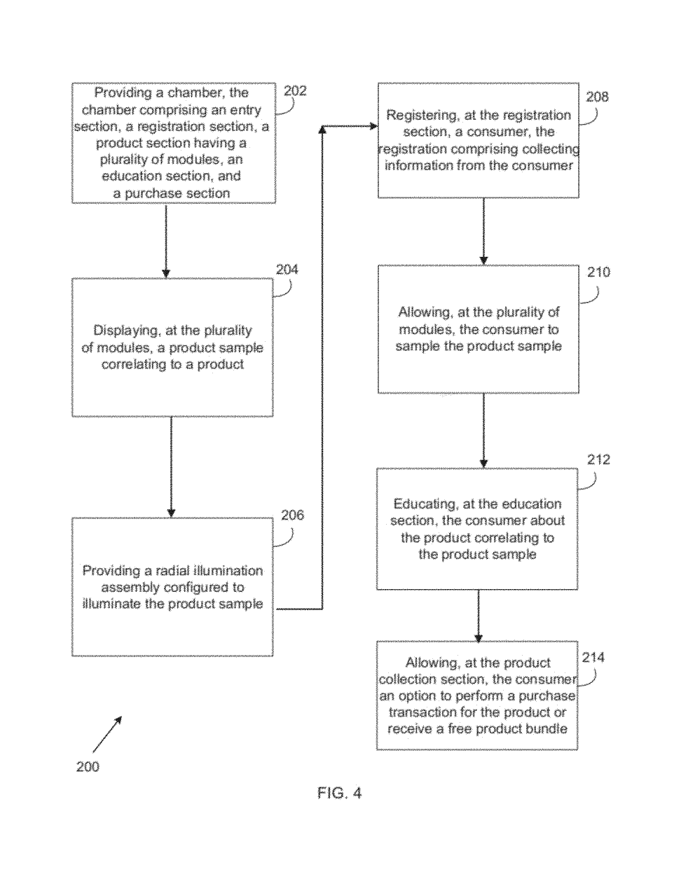

As referenced in flowchart of FIG. 4, a method 200 for distributing product samples to promote sales in an ornamental and pressure-free environment is configured to enable a consumer 130a-f to sample a product in a strategically lighted chamber 102, and become educated about the product with no sales pressure before offering a final option of purchasing the product or receiving a free product bundle.

The method 200 comprises an initial Step 202 of providing a chamber 102, the chamber 102 comprising an entry section 104, a registration section 106, a product section 110 having a plurality of modules 112a-e, an education section 114, and a purchase section. The chamber 102 may be arranged similarly to a convention center, or a show room, or a sampling room that are often used to promote products and services. The chamber 102 comprises an entry section 104 where the consumer 130a-f initially enters the chamber 102. The consumer 130a-f does not pay a fee to enter the chamber 102 through the entry section 104. This cost-free aspect of the system 100 is efficacious for creating a pressure free environment that enables the consumer 130a-f to sample and learn about the products for potentially no cost at all.

A Step 204 may further include displaying, at the plurality of modules 112a-e, a product sample correlating to a product. The product may include, without limitation, a commercially available item, a service, a free item or service offered by a government agency, and a packet of information. The modules 112a-e may include a table or stand having a product display that aesthetically displays a product sample.

In some embodiments of the method 200, a Step 206 comprises providing a radial illumination assembly 120 configured to illuminate the product sample, the radial illumination assembly 120 comprising center region 122 and a plurality of arms 124a-h disposed to extend radially from the center region 122, the plurality of arms 124a-h carrying a plurality of lights 126a-c configured to emit light towards the plurality of modules 112a-e.

Another Step 208 involves registering, at the registration section 106, a consumer 130a-f, the registration comprising collecting information from the consumer 130a-f. The registration section 106 is disposed adjacent to the entry section 104. The consumer 130a-f registers at the registration section 106 by providing information at an information input portion 108.

A Step 210 may include allowing, at the plurality of modules 112a-e, the consumer 130a-f to sample the product sample. The consumer 130a-f may wander freely in the chamber 102 moving from product-to-product, sampling products, inquiring about products, and receiving no sales pressure from a salesperson or marketing apparatus.

A Step 212 comprises educating, at the education section 114, the consumer 130a-f about the product correlating to the product sample. The education is an optional section of the chamber 102, where the consumer 130a-f may receive help in better understanding the products and information pertinent to the products, such as specs, prices, and delivery options. The education section 114 may include a kiosk, a sales person, or a help desk that are set up to display and distribute educational media that is pertinent to the product sample.

A final Step 214 comprises allowing, at the product collection section 116, the consumer 130a-f an option to perform a transaction for the product, or receive a free product bundle, the product bundle comprising the product or the product sample or both. The product collection section 116 offers the consumer 130a-f an option to receive the product or product sample for free, or purchase the product. The consumer 130a-f may receive a free product bundle consisting of the product or product sample, or both. The consumer 130a-f also has the option of transacting a purchase for the products that are displayed at the modules 112a-e.

While the inventor's above description contains many specificities, these should not be construed as limitations on the scope, but rather as an exemplification of several preferred embodiments thereof. Many other variations are possible. For example, the radial illumination assembly may be square-shaped, or triangular with lighting on the perimeter of the assembly. Accordingly, the scope should be determined not by the embodiments illustrated, but by the appended claims and their legal equivalents.

What is claimed is:

1. A method for distributing product samples to promote sales in an ornamental and pressure-free environment, the method comprising:
providing a chamber, the chamber comprising an entry section, a registration section, a product section having a plurality of modules, an education section, and a purchase section;
displaying, at the plurality of modules, a product sample correlating to a product;
providing a radial illumination assembly configured to illuminate the product sample, the radial illumination assembly comprising center region and a plurality of arms disposed to extend radially from the center region, the plurality of arms carrying a plurality of lights configured to emit light towards the plurality of modules;
registering, at the registration section, a consumer, the registration comprising collecting information from the consumer;
allowing, at the plurality of modules, the consumer to sample the product sample;
educating, at the education section, the consumer about the product correlating to the product sample; and
allowing, at the product collection section, the consumer an option to perform a purchase transaction for the product or receive a free product bundle.

2. The method of claim 1, wherein the chamber includes at least one member selected from the group consisting of: a show room, a convention center, a boutique, and a sampling room

3. The method of claim 1, wherein the plurality of modules comprise a table or a stand.

4. The method of claim 1, wherein the radial illumination assembly is defined by a generally multi-fold radial symmetry shape.

5. The method of claim 1, wherein the registration section comprises an information input portion configured to collect information from the consumer.

6. The method of claim 5, wherein the information input portion includes at least one member selected from the group consisting of: a digital display, a data entry person, a card reading device, and a paper form.

7. The method of claim 1, wherein the education section is configured to enable the distribution of an education media pertinent to the product.

8. The method of claim 1, wherein the product collection section comprises a point-of-collection portion configured to perform a purchase transaction for the product or distribute the free product bundle, the free product bundle comprising the product or the product sample or both.

9. The method of claim 1, wherein the step of displaying, at the plurality of modules, a product sample correlating to a product, further includes displaying the product sample on a product display.

10. The method of claim 1, wherein the step of providing a radial illumination assembly configured to illuminate the product sample, further comprises varying the color and the intensity of illumination.

11. The method of claim 1, wherein the information collected from the consumer includes at least one member selected from the group consisting of: personal information, demographics, desired products, history of purchasing products, and preferred payment methods.

12. The method of claim 1, further including a step of marketing the product to the consumer based on the collected information at the registration portion.

13. A method for distributing product samples to promote sales in an ornamental and pressure-free environment, the method comprising:
providing a chamber, the chamber comprising an entry section, a registration section, a product section having a plurality of modules, an education section, and a purchase section;
displaying, at the plurality of modules, a product sample correlating to a product;
providing a radial illumination assembly configured to illuminate the product sample, the radial illumination assembly comprising center region and a plurality of arms disposed to extend radially from the center region, the plurality of arms carrying a plurality of lights configured to emit light towards the plurality of modules;
registering, at the registration section, a consumer, the registration comprising collecting information from the consumer;
marketing the product to the consumer based on the collected information at the registration portion;
allowing, at the plurality of modules, the consumer to sample the product sample;
educating, at the education section, the consumer about the product correlating to the product sample; and
allowing, at the product collection section, the consumer an option to perform a transaction for the product or receive a free product bundle at a point-of-collection portion.

14. A system for distributing product samples to promote sales in an ornamental and pressure-free environment, the system comprising:
a chamber, the chamber comprising an entry section, a registration section, a product section, an education section, and a purchase section, the chamber defined by a generally circular shape having a central hub;
a plurality of modules disposed in a spaced-apart relationship in the product section, the plurality of modules comprising a product display;
a radial illumination assembly configured to illuminate the plurality of modules, the radial illumination assembly comprising center region and a plurality of arms disposed to extend radially from the center region, the plurality of arms carrying a plurality of lights configured to emit light towards the plurality of modules;
a product sample correlating to a product, the product sample configured to display on the plurality of modules;
a registration portion configured to collect information;
an educational media configured to educate; and
a point-of-collection portion configured to perform a transaction.

15. The system of claim 14, wherein the product display of the plurality of modules is configured to enable the display of a product sample correlating to a product.

16. The system of claim 15, wherein the radial illumination assembly is defined by a generally multi-fold radial symmetry shape.

17. The system of claim 16, wherein the multi-fold radial symmetry shape forms a snowflake shape.

18. The system of claim 17, wherein the registration section comprises an information input portion.

19. The system of claim 18, wherein the education section is configured to enable the distribution of an education media that is pertinent to the product.

20. The system of claim 19, wherein the product collection section comprises a point-of-collection portion configured to perform a transaction for the product or distribute the free product bundle, the free product bundle comprising the product or the product sample or both.
